(19) United States
(12) Patent Application Publication
(10) Pub. No.: US 2026/0172168 A1
(43) Pub. Date: Jun. 18, 2026

(54) INFORMATION DETERMINATION AND PROCESSING IN WIRELESS COMMUNICATIONS

(71) Applicant: ZTE Corporation, Shenzhen (CN)

(72) Inventors: Shuaihua KOU, Shenzhen (CN); Xianghui HAN, Shenzhen (CN); Wei GOU, Shenzhen (CN); Jing SHI, Shenzhen (CN); Xingguang WEI, Shenzhen (CN); Mengzhu CHEN, Shenzhen (CN)

(73) Assignee: ZTE Corporation, Shenzhen (CN)

(21) Appl. No.: 19/534,321

(22) Filed: Feb. 9, 2026

Related U.S. Application Data
(63) Continuation of application No. PCT/CN2023/112179, filed on Aug. 10, 2023.

(51) Int. Cl. H04L 5/00; H04L 1/00; H04W 72/0457

(52) U.S. Cl. CPC H04L 5/0046; H04L 1/0067; H04W 72/0457

(57) ABSTRACT

This document generally relates to wireless communication that includes a network device that transmits, and a user device that receives, a plurality of configurations. Each configuration includes at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions. The user device determines a transport block size (TBS) based on at least one of the plurality of configurations, and the user device and the network device communicate a transport block with the TBS.

### CROSS-REFERENCE TO RELATED APPLICATION(S)

This application is a continuation of co-pending International Application No. PCT/CN2023/112179, filed Aug. 10, 2023. The contents of International Application No. PCT/CN2023/112179 are herein incorporated by reference in their entirety.

### TECHNICAL FIELD

This document is directed generally to information determination and processing in wireless communications.

### BACKGROUND

In wireless communication systems, in ultra-reliable low latency communications (URLLC), multiple downlink control information (DCI) formats are supported to improve the reliability of DCI. In addition, more than one transmission reception point (TRP) or panel may be configured to improve the reliability and throughput for downlink and uplink transmission. Also, a sub-band may be used to achieve full duplex operation in time division duplex (TDD) systems. Ways to leverage such DCI formats, TRPs, panels, and sub-bands in order to improve flexibility in the way information is determined and processed may be desirable.

### SUMMARY

This document relates to methods, systems, apparatuses and devices for wireless communication. In some implementations, a method for wireless communication includes: receiving, by a user device, a plurality of configurations, wherein each configuration includes at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions; determining, by the user device, a transport block size (TBS) based on at least one of the plurality of configurations; and communicating, by the user device, a transport block with the TBS.

In some other implementations, a method for wireless communication includes: transmitting, by a network device, a plurality of configurations, wherein each configuration includes at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions; and communicating, by the network device, a transport block with a transport block size (TBS) determined based on at least one of the plurality of configurations.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of a method for wireless communication.

FIG. 3 shows a flow chart of a method for wireless communication.

FIG. 4 shows a flow chart of a method for wireless communication.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

The present description describes various embodiments of systems, apparatuses, devices, and methods for wireless communications related to data channel scheduling.

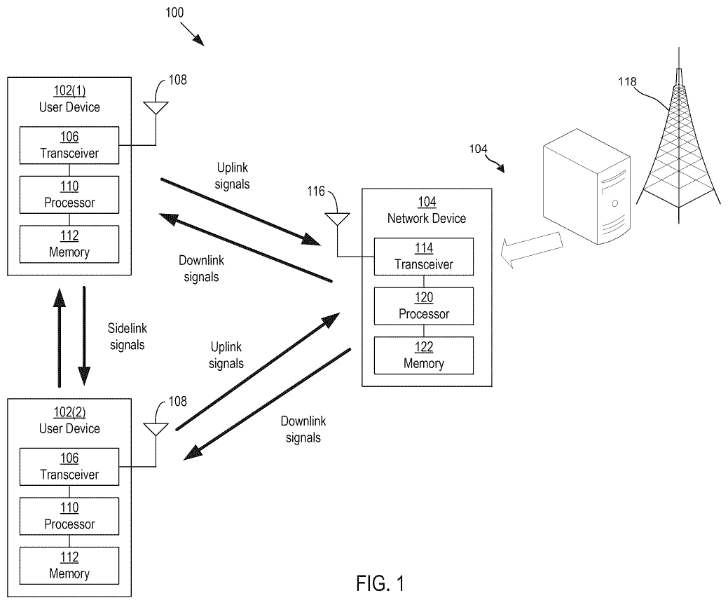

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one network device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, aplane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to a another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

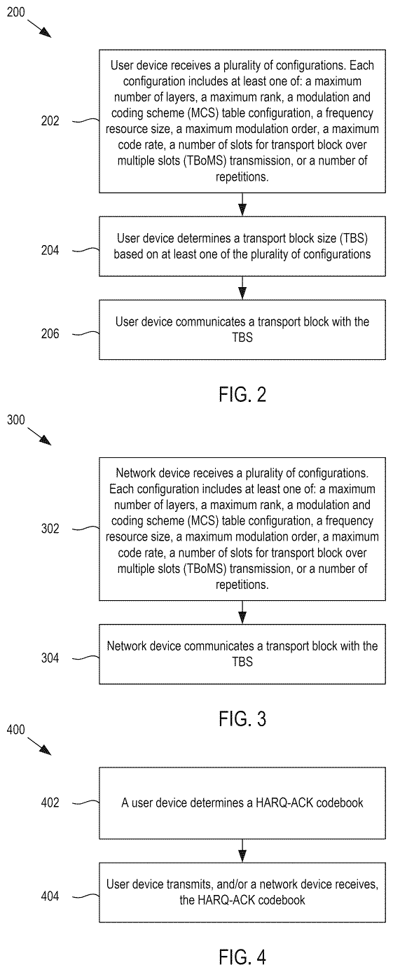

FIG. 2 is a flow chart of an example method 200 for wireless communication that involves transport block sizes (TBS). At block 202, a user device 102 receives a plurality of configurations. Each configuration may include at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions. At block 204, the user device 102 determines a transport block size (TBS) based on at least one of the plurality of configurations. At block 206, the user device 102 communicates (e.g., transmits or receives) a transport block with the TBS. For example, the user device 102 may transmit the transport block with the TBS in the uplink direction or receive the transport block with the TBS in the downlink direction.

FIG. 3 is a flow chart of another example method 300 for wireless communication that involves transport block sizes (TBS). At block 302, a network device 104 transmits a plurality of configurations.

Each configuration includes at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions. At block 304, the network device 104 communicates (e.g., transmits or receives) a transport block with a transport block size (TBS) determined based on at least one of the plurality of configurations. For example, the network device 104 may receive a transport block with the TBS in the uplink direction, or transmit the transport block with the TBS in the downlink direction.

In some implementations of the method 200 and/or the method 300, wherein each of the plurality of configurations corresponds to at least one of or a respective combination of: a respective downlink control information (DCI) format, a respective transmission reception point (TRP), a respective panel, a respective bandwidth part (BWP), or a respective sub-band.

In some implementations of the method 200 and/or the method 300, the TBS includes a limited buffer rate matching (LBRM) TBS, and wherein for a data channel, a largest value or a smallest value of the plurality of configurations is used to determine the LBRM TBS.

In some implementations of the method 200 and/or the method 300, the TBS includes a limited buffer rate matching (LBRM) TBS, and a value for a downlink control information (DCI) format in one of the plurality of configurations is used to determine the LBRM TBS. In some of these implementations, the value for the DCI format includes a largest value or a smallest value for a plurality of DCI formats in the plurality of configurations. In other of these implementations, the value for the DCI format includes a largest value or a smallest value for the DCI format in the plurality of configurations. In addition or alternatively, in some of these implementations, the plurality of configurations includes a subset of configurations, wherein each configuration in the subset includes a respective value for the DCI format and for a respective one of one or more bandwidth parts (BWPs).

In some implementations of the method 200 and/or the method 300, the TBS includes a limited buffer rate matching (LBRM) TBS, and a value for a transmission reception point (TRP) or a panel in one of the plurality of configurations is used to determine the LBRM TBS. In some of these implementations, the value for the TRP or the panel includes a largest value or a smallest value for a plurality of TRPs or for a plurality of panels in the plurality of configurations. In other of these implementations, the value for the TRP or the panel includes a largest value or a smallest value for the TRP or the panel in the plurality of configurations.

In some implementations of the method 200 and/or the method 300, the TBS includes a limited buffer rate matching (LBRM) TBS, and a value for a bandwidth part (BWP) or a sub-band in one of the plurality of configurations is used to determine the LBRM TBS. In some of these implementations, the value for the BWP or the sub-band includes a largest value or a smallest value for a plurality of BWPs or a plurality of sub-bands in the plurality of configurations. In other of these implementations, the value for the BWP or the sub-band includes a largest value or a smallest value for the BWP or the sub-band in the plurality of configurations.

In some implementations of the method 200 and/or the method 300, each of the plurality of configuration corresponds to respective one of a plurality of time domain resource allocation (TDRA) configurations. In some of these implementations, the TBS includes a limited buffer rate matching (LBRM) TBS, and wherein for a data channel allocated with one of the plurality of TDRA configurations, a value for the one of the plurality of time domain resource allocation (TDRA) configurations is used to determine the LBRM TBS. Additionally, in some of these implementations, the value for the one of the plurality of TDRA configurations includes a largest value or a smallest value for the plurality of TDRA configurations. In addition or alternatively, in some of these implementations, a number of repetitions associated with a TDRA configuration is used to determine whether the TDRA configuration is valid. In addition or alternatively, in some of these implementations, a largest number of repetitions among the plurality of TDRA configurations is used to determine whether one of the plurality of TDRA configurations is valid.

Other implementations may be possible, including those where a hybrid automatic repeat request (HARQ)-acknowledgment (ACK) codebook is determined without necessarily a TBS size also being determined. For example, FIG. 4 is a flow chart of an example method 400 for wireless communication involving a HARQ-ACK codebook. At block 402, a user device 102 may determine (or construct or generate) a HARQ-ACK codebook. At block 404, the user device 102 may transmit, and/or a network device 104 may receive, the HARQ-ACK codebook.

Further details, any of which may be part of or implemented in the method 200, the method 300, and/or the method 400, and/or other methods in any of various implementations, are now described.

For at least some implementations, a data channel may carry one or more multiple transport blocks (TB). The user device 102 may determine a transport block size (TBS) for each of one or more TBs based on at least one of: a resource size, a code rate, a modulation order, or a number of layers.

The resource size may be the total number of resource elements (RE) allocated for the data transmission. For example, the resource size may be the total number of REs of the data channel that does not include the RE for a demodulation reference signal (DMRS) transmission and the overhead REs. In some implementations, the network 104 may configure the value of the overhead REs for the user device 102. In other implementations, the network 104 may not configure the value of the overhead REs for the user device 102, in which case a default overhead RE value of 0 may be used.

Additionally, in some implementations, a limited buffer rate matching (LBRM) TBS may be determined by a maximum number of multiple input multiple output (MIMO) layers, a highest modulation order, a maximum code rate, and/or a specific resource size. The specific resource size may be determined based on the frequency resource. For example, the resource size (e.g., the number of REs) may be Z*N, where Z is the number of REs in a physical resource block (PRB) and N is the number of physical resource blocks (PRBs). For at least some of these implementations, Z is a constant or fixed value, as used by the user device 102 and/or other communication nodes in the wireless communication system 100. An example for Z is 156, although other values or constants may be used. Additionally, the value of N may depend on the bandwidth (or the number of the PRBs) of the bandwidth part (BWP) or the bandwidth (or the number of the PRBs) of the carrier (or serving cell). In event that the network 104 configures more than one BWP, the maximum number of PRBs across all the configured BWPs may be used to determine the value of N. Table 1 below shows the value N depending on the number of PRBs of the bandwidth in the wireless communication system 100. For example, Table 1 lists a plurality of candidate values for N: {32, 66, 107, 135, 162, 217, 273}. Each candidate value corresponds to a respective range of maximum number of PRBs across all configured BWPs. In operation, the user device 102 may identify a maximum number of PRBs across all configured BWPs. In turn, the user device 102 may identify a range among the plurality of ranges of maximum number of PRBs in which the identified maximum number of PRBs falls. Then, the user device 102 may determine the value of N that corresponds to the identified range of maximum of PRBs, and select that value for the value of N for the resource size. As example, where the maximum number of PRBs across all the configured BWP is less than 33, N is 32 according to Table 1. As another example, where the maximum number of PRBs across all the configured BWP is greater than or equal to 33, and smaller than or equal to 66, N is 66 according to Table 1.

TABLE 1

| Maximum number of PRBs across all configured BWP | N |
|---|---|
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

Additionally, in some embodiments, the network 104 may configure a plurality of configurations for the user device 102. Each of the plurality of configurations may include at least one of: a maximum number of multiple-input multiple-output (MIMO) layers, a maximum rank, a modulation and coding scheme (MCS) table configuration, a frequency resource size, a maximum modulation order, a maximum code rate, a number of slots for a transport block over multiple slots (TBoMS) transmission, or a number of repetitions.

For at least some embodiments, the maximum code rate and/or the maximum modulation order may be determined based on the MCS table configuration. In addition, in some embodiments, a given configuration may explicitly include at least one of the code rate or the maximum modulation order.

Additionally, in some embodiments, a first configuration of the plurality of configurations may include at least one of a first maximum number of MIMO layers (L1), a first maximum rank (R1), a first MCS table (MCS table 1) corresponding to a first maximum modulation order (M1), and/or a first maximum code rate (C1), a number of slots for TBoMS transmission (NS1), and/or a first frequency resource size (F1) corresponding to N1 (a value of N in Table 1). In addition or alternatively, the first configuration may include at least one of the first maximum modulation order M1 and/or the first maximum code rate C1.

Additionally, in some embodiments, a second configuration of the plurality of configurations may include at least one of a second maximum number of MIMO layers (L2), a second maximum rank (R2), a second MCS table (MCS table 2) corresponding to a second maximum modulation order (M2) and/or a second maximum code rate (C2), a number of slots for TBoMS transmission (NS2), and/or a second frequency resource size (F1) corresponding to N2 (a value of N in Table 1). In addition or alternatively, the second configuration may include at least one of the second maximum modulation order M2 and/or the second maximum code rate C2.

Correspondingly, in general, an n-th configuration of the plurality of configurations may include at least one of an n-th maximum number of MIMO layers (Ln), an n-th maximum rank (Rn), an n-th MCS table n (MCS table n) corresponding to an n-th maximum modulation order (Mn) and/or a n-th maximum code rate (Cn), a number of slots for TBoMS transmission (NSn), and/or an n-th frequency resource size (Fn) corresponding to Nn (a value of N in Table 1). In addition or alternatively, the n-th configuration may include at least one of the n-th maximum modulation order Mn and/or the n-th maximum code rate Cn.

In addition or alternatively, in some embodiments, the network 104 may configure a plurality of control information formats for the user device 102. In particular of these embodiments, one of the plurality of control formats may schedule one or more data channels. The network 104 may configure the plurality of configurations for the plurality of control information formats or the data channel scheduled by the plurality of control information formats, respectively. More specifically, the network 104 may configure a first configuration for a first control information format or the data channel scheduled by the first control information format. Also, the network 104 may configure a second configuration for a second control information format or the data channel scheduled by the second control information format, and so on. The control information may include DCI (downlink control information) or SCI (sidelink control information). Additionally, the data channel may include a PDSCH (physical downlink shared channel), a PUSCH (physical uplink shared channel), or a PSSCH (physical sidelink shared channel).

In one implementation, a largest value or a smallest value of a certain parameter among the plurality of configurations may be used to determine a transport block size (TBS) or a limited buffer rate matching (LBRM) TBS for a transport block (TB). The transport block may be scheduled by any of the plurality of DCI formats. In particular of these embodiments, the largest or smallest value of the maximum number of MIMO layers (e.g., the largest or smallest one of the L1, L2, . . . , Ln), the largest or smallest value of the maximum rank (e.g., the largest one of the R1, R2, . . . , Rn), the largest or smallest modulation order (e.g., the largest or smallest one of the M1, M2, . . . , Mn), the largest or smallest value of the maximum code rate (e.g., the largest or smallest one of the C1, C2, . . . , Cn), and/or the largest or smallest frequency resource size (e.g., the largest or smallest one of the F1, F2, . . . , Fn, or the largest or smallest one of the N1, N2, . . . , Nn), or the largest or smallest number of slots for TBoMS transmission (e.g., the largest or smallest one of the NS1, NS2, . . . , NSn), across the plurality of configurations may be used to determine the TBS or the LBRM TBS for the transport block.

For example, suppose the maximum number of MIMO layers is used to determine the TBS or the LBRM TBS. Further, suppose the network 104 configures the maximum number of MIMO layers for DCI format 1 to be 6, and the maximum number of MIMO layers for DCI format 2 to be 4. In turn, the value 6 for the maximum number of MIMO layers may be used to determine the LBRM TBS for the transport block scheduled by DCI format 1 or DCI format 2.

In another implementation, the parameter of one of the plurality of configurations may be used to determine the TBS or the LBRM TBS for the transport block scheduled by the DCI format corresponding to the one of the plurality of configurations. More specifically, the parameters of the first configuration (e.g., L1, R1, M1, C1, F1, NS1, or N1) may be used to determine the TBS or the LBRM TBS for the transport block scheduled by the first control information format. The parameters of the second configuration (e.g., L2, R2, M2, C2, F2, NS2, or N2) may be used to determine the TBS or the LBRM TBS for the transport block scheduled by the second control information format, and so on. Accordingly, in general, the parameters of the n-th configuration (e.g., Ln, Rn, Mn, Fn, Cn, NSn, or Nn) may be used to determine the TBS or the LBRM TBS for the transport block scheduled by the n-th control information format.

In a third implementation, the parameter of one of the plurality of configurations may be used to determine the TBS or the LBRM TBS for the transport block scheduled by any DCI format. Which one of the plurality of configurations that is used to determine the TBS or the LBRM TBS may be configured by the network 104 and/or specified by the protocol. For example, the network 104 may configure that the first configuration (e.g., L1, R1, M1, C1, F1, NS1, and/or N1) may be used to determine the TBS or the LBRM TBS for the transport block scheduled by any control information format. As another example, the protocol may define that the second configuration (e.g., L2, R2, M2, C2, F2, NS2, and/or N2) may be used to determine the TBS or the LBRM TBS for the transport block scheduled by any control information format.

In addition or alternatively, in some embodiments, the network 104 may configure the same value for the same parameter among the plurality of configurations. From the perspective of the user device 102, the user device 102 does not expect the parameters to have different values across the plurality of configurations, and in turn, a parameter of any of the plurality of the configurations may be used to determine the TBS or the LBRM TBS for the transport block scheduled by any control information format.

Additionally, in some embodiments, the network 104 may configure at least one downlink (DL) bandwidth part (BWP) for the user device 102. In addition or alternatively, the network 104 may configure at least one DL sub-band for the user device 102. In some embodiments, the DL BWP and the DL sub-band may be configured with different frequency resources and/or different time domain resources. Also, a data channel may be transmitted on the DL BWP or the DL sub-band.

As an example, the network 104 may configure the first configuration for the DL BWP, and may configure the second configuration for the DL sub-band.

In this example, in one implementation, a largest or smallest value of the same parameter among the plurality of configurations may be used to determine the TBS or the LBRM TBS for a transport block transmitted in the DL BWP or the DL sub-band. In particular of these implementations, the largest or smallest value of the maximum number of MIMO layers (e.g., the largest or smallest one of the L1, L2, . . . , Ln), the largest or smallest value of the maximum rank (e.g., the largest or smallest one of the R1, R2, . . . , Rn), the largest or smallest modulation order (e.g., the largest or smallest one of the M1, M2, . . . , Mn), the largest or smallest value of the maximum code rate (e.g., the largest or smallest one of the C1, C2, . . . , Cn), or the largest or smallest frequency resource size (e.g., the largest or smallest one of the F1, F2, . . . , Fn, or the largest or smallest one of the N1, N2, . . . , Nn), or the largest or smallest number of slots for TBoMS transmission (e.g., the largest or smallest one of the NS1, NS2, . . . , NSn) across the plurality of configurations may be used to determine the TBS or the LBRM TBS for the transport block.

Suppose as an example, the maximum number of frequency resource size is used to determine the TBS or the LBRM TBS for the transport block. Further, suppose the network 104 configures the DL BWP to include 130 PRBs. The corresponding N is 135 according to Table 1. Also, suppose the network 104 configures the DL sub-band to include 60 PRBs. The corresponding N is 66 according to Table 1. In turn, the value 135 of N is used to determine the LBRM TBS for the transport block transmitted in the DL BWP or DL sub-band.

In other implementation, the parameter of one of the plurality of configurations may be used to determine the TBS or the LBRM TBS for the transport block transmitted on the DL BWP or DL sub-band corresponding to the one of the plurality of configurations. In particular of these implementations, the parameters of the first configuration (e.g., L1, R1, M1, C1, F1, N1, or NS1) may be used to determine the TBS or the LBRM TBS for the transport block transmitted in the DL BWP. The parameters of the second configuration (e.g., L2, R2, M2, C2, F2, N2, or NS2) may be used to determine the TBS or the LBRM TBS for the transport block transmitted in the DL sub-band, and so on. Accordingly, in general, the parameters of an n-th configuration (e.g., Ln, Rn, Mn, Cn, Fn, Nn, or NSn) may be used to determine the TBS or the LBRM TBS for the transport block transmitted in the DL sub-band.

In a third implementation, the parameter of one of the plurality of configurations may be used to determine the TBS or the LBRM TBS for the transport block transmitted in the DL BWP or the DL sub-band. Which one of the plurality of configurations is used to determine the TBS or the LBRM TBS may be configured by the network 104 and/or specified by the protocol. For example, the network 104 may configure the first configuration (e.g., L1, R1, M1, C1, F1, N1, or NS1) to be used to determine the TBS or the LBRM TBS for the transport block transmitted in the DL BWP. As another example, the protocol may specify that the second configuration (e.g., L2, R2, M2, C2, F2, N2, or NS2) is to be used to determine the TBS or the LBRM TBS for the transport block transmitted in the DL sub-band.

Additionally, in some embodiments, the network 104 may configure at least one uplink (UL) bandwidth part (BWP) for the user device 102. In addition or alternatively, the network 104 may configure at least one UL sub-band for the user device 102. In some embodiments, the UL BWP and the UL sub-band may be configured with different frequency resources and/or different time domain resources. Also, a data channel may be transmitted on the DL BWP or the DL sub-band.

As an example, the network 104 may configure the first configuration for the UL BWP, and may configure the second configuration for the UL sub-band. The above methods used for DL BWP and DL sub-band may be applied to the UL BWP and UL sub-band by replacing DL BWP with UL BWP, and replacing DL sub-band with UL sub-band.

In addition or alternatively, in some embodiments, the network 104 may configure a plurality of transmission reception points (TRP)s or panels for the user device 102. In addition or alternatively, the user device 102 may report that it supports a plurality of panels. The plurality of TRPs or panels may include a first TRP or a first panel, a second TRP or a second panel, including up to an n-th TRP or an n-th panel. The network 104 may configure a data channel to be associated with a given TRP or a given panel. In addition or alternatively, the network 104 may configure a control information to be associated with a given TRP or a given panel. For such embodiments, the data channel scheduled by the control information is also associated with the TRP. Alternatively, the control information may indicate which TRP is associated with its scheduled data channel.

In addition, a TRP may be deployed at the network 104. The TRP may be at least used for the network 104 to communicate (e.g., transmit or receive) signals with the user device 102. For example, it can be a module integrated into the network device 104 in FIG. 1. For another example, it can be standalone module connected to the network device 104 in FIG. 1. More than one TRP can be deployed at the network 104 in a serving cell. Each TRP may be able to communicate signals with the user device 102. The network device 104 may separately process the signal on the more than one TRP. The signals on the different TRP may carry the same or different information. The more than one TRP may be able to communicate signals with the user device 102 simultaneously. Each TRP may have (or be configured with) a TRP index, or associated with a control resource set pool index. From the user device 102 perspective, a TRP may be identified by a TRP index or a control resource set pool index. From the user device 102 perspective, a signal associated with a control resource set may be transmitted or received by the corresponding TRP.

In addition, a panel may be equipped at the user device 102. The panel may be at least used for the user device 102 to communicate (e.g., transmit or receive) signals with the network 104. In the wireless communication system 100, a panel may be defined as a group of antenna elements that controls a beam independently. Within a panel, one beam can be selected and used for DL reception or UL transmission.

Across different panels, multiple beams (each selected per panel) may be used for DL reception or UL transmission. A user device 102 may be equipped with more than one panel. The more than one panel may be able to communicate signals with the network 104 simultaneously. The signals via the different panels may carry the same or different information. A panel may have (or be configured with) a panel index, or associated with a control resource set pool index. From the user device 102 perspective, a panel may be identified by a panel index or a control resource set pool index. For example, a signal associated with a control resource set pool index may be communicated (e.g., transmit or receive) by the corresponding panel at the user device 102.

Also, in some embodiments, the network 104 may configure the plurality of configurations for the plurality of TRP or for the plurality of panels, respectively. In particular of these embodiments, the network 104 may configure a first configuration of the plurality of configurations for the a first TPR or for a first panel, may configure a second configuration of the plurality of configurations for a second TPR or for a second panel, and so on, including up to configuring an n-th configuration of the plurality of configurations for the n-th TPR or for the n-th panel.

In one implementation, a largest or smallest one of the same parameter among the plurality of configurations may be used to determine the TBS or the LBRM TBS for a transport block. In any of various embodiments, the transport block may be associated with any TRP or any panel, and/or may be scheduled by the control information associated with any TRP or any panel. In particular embodiments, the largest or smallest value of the maximum number of MIMO layers (e.g., the largest or smallest one of the L1, L2, . . . , Ln), the largest or smallest value of the maximum rank (e.g., the largest or smallest one of the R1, R2, . . . , Rn), the largest or smallest modulation order (e.g., the largest or smallest one of the M1, M2, . . . , Mn), the largest or smallest value of the maximum code rate (e.g., the largest or smallest one of the C1, C2, . . . , Cn), or the largest or smallest frequency resource size (e.g., the largest or smallest one of the F1, F2, . . . , Fn, or the largest or smallest one of the N1, N2, . . . , Nn), or the largest or smallest number of slots for TBoMS transmission (e.g., the largest or smallest one of the NS1, NS2, . . . , NSn) across the plurality of configurations may be used to determine the TBS or the LBRM TBS for the transport block.

Suppose for example, that the maximum number of MIMO layers is used to determine the TBS or the LBRM TBS for the transport block. The network 104 may configure that the maximum number of MIMO layers for the first TRP or the first panel to be 8, and the maximum number of MIMO layers for the second TRP or the second panel to be 4. In turn, the value 8 of maximum number of MIMO layers may be used to determine the LBRM TBS for the transport block associated with the first TRP or the second TRP.

In another implementation, a parameter of one of the plurality of configurations may be used to determine the TBS or the LBRM TBS for the transport block associated with the TRP or the panel corresponding to the one of the plurality of configurations. In particular of these implementations, the parameters of the first configuration (e.g., L1, R1, M1, C1, F1, N1 or NS1) may be used to determine the TBS or the LBRM TBS for the transport block associated with the first TRP or the first panel. The parameters of the second configuration (e.g., L2, R2, M2, C2, F2, N2, or NS2) may be used to determine the TBS or the LBRM TBS for the transport block associated with the second TRP or the second panel, and so on, including the parameters of the n-th configuration (e.g., Ln, Rn, Mn, Fn, Cn, Nn, or NSn) may be used to determine the TBS or the LBRM TBS for the transport block associated with the n-th TRP or the n-th panel.

In a third implementation, the parameter of one of the plurality of configurations may be used to determine the TBS or the LBRM TBS for any transport block. Which one of the plurality of configurations that is used to determine the TBS or the LBRM TBS may be configured by the network 104 and/or may be specified by the protocol. For example, the network 104 may configure that the first configuration (e.g., L1, R1, M1, C1, F1, N1, or NS1) may be used to determine the TBS or the LBRM TBS for the transport block associated with any of the TRPs or any of the panels. Alternatively, the protocol may define that the second configuration (e.g., L2, R2, M2, C2, F2, N2, or NS2) may be used to determine the TBS or the LBRM TBS for the transport block associated with any of the TRPs or any of the panels.

In addition, in some embodiments, the network 104 may configure a plurality of BWPs for the user device 102. In addition or alternatively, the network 104 may configure a plurality of control information formats, a plurality of TRPs, and/or a plurality of panels. For the plurality of BWPs, the network 104 may configure a plurality of configurations for the plurality of control information formats, the plurality of TRPs, and/or the plurality of panels. Each of the plurality of configurations may correspond to (or be associated with, or be configured for) each of the plurality of control information formats, each of the plurality of TRPs, or each of the plurality of panels for each of the plurality of BWPs.

In one implementation, a largest or smallest one of the same parameter among the plurality of configurations may be used to determine the TBS or the LBRM TBS for a transport block in accordance with the above methods. The transport block may be scheduled by any of the plurality of DCI formats, or transmitted on any of the plurality of BWPs, or associated with any of the TRPs or any of the panels. In particular of these implementations, the largest or smallest value of the maximum number of MIMO layers (e.g., the largest or smallest one of the L1, L2, . . . , Ln), the largest or smallest value of the maximum rank (e.g., the largest or smallest one of the R1, R2, . . . , Rn), the largest or smallest modulation order (e.g., the largest or smallest one of the M1, M2, . . . , Mn), the largest or smallest value of the maximum code rate (e.g., the largest or smallest one of the C1, C2, . . . , Cn), or the largest or smallest frequency resource size (e.g., the largest or smallest one of the F1, F2, . . . , Fn, or the largest or smallest one of the N1, N2, . . . , Nn), or the largest or smallest number of slots for TBoMS transmission (e.g., the largest or smallest one of the NS1, NS2, . . . , NSn) across the plurality of configurations may be used to determine the TBS or the LBRM TBS for the transport block.

To illustrate, suppose the maximum rank is used to determine the TBS or the LBRM TBS for the transport block. Further, suppose the network 104 configures two BWPs for the user device 102, denoted by BWP 1 and BWP 2. Additionally, the network 104 may configure the 2 DCI formats for the user device 102, denoted by DCI format 1 and DCI format 2. The maximum rank configured for DCI format 1 for BWP 1, for DCI format 2 for BWP 1, for DCI format 1 for BWP 2, and for DCI format 2 for BWP 2 are 4, 6, 7, and 8, respectively. In turn, in some examples, the largest maximum rank value of ‘8’ may be used to determine the TBS or the LBRM TBS for a transport block.

In another implementation, a largest or smallest one of the same parameter in the plurality of configurations for a particular control information format, a particular TRP, or a particular panel across the plurality of BWPs may be used to determine the TBS or the LBRM TBS for a transport block scheduled by the control information format, or associated with the TRP or the panel. In particular of these implementations, a largest or smallest one of the same parameter in the plurality of configurations for a particular control information format, a particular TRP, or a particular panel across the plurality of BWPs may be used to determine the TBS or the LBRM TBS for a transport block scheduled by the particular control information format, or associated with the particular TRP or the particular panel. Still referring the example above to illustrate this other implementation, suppose the transport block is scheduled by DCI format 1. The largest maximum rank corresponding to DCI format 1 is ‘7’, which in turn may be used to determine the LBRB TBS. Additionally, the transport block may be transmitted in BWP 1 or in BWP 2. As another example illustration, suppose the transport block is scheduled by DCI format 2. The largest maximum rank corresponding to DCI format 2 is ‘8’, which in turn may be used to determine the LBRM TBS. Additionally, the transport block may be transmitted in BWP 1 or BWP 2.

In a third implementation, a largest or smallest one of the same parameter in the plurality of configurations for a particular BWP across the plurality of control information formats, across the plurality of TRPs, or across the plurality of panels may be used to determine the TBS or the LBRM TBS. In particular of these implementations, the largest or smallest one of the same parameter in the configurations for the particular BWP across the plurality of control information formats, the plurality of TRPs, or the plurality of panels may be used to determine the TBS or the LBRM TBS. Still referring the example above, for the transport block transmitted in BWP 1, the corresponding maximum rank is ‘6’, which may be used to determine the LBRB TBS. The transport block may be scheduled by DCI format 1 or DCI format 2. As another example illustration, for the transport block transmitted in BWP 2, the corresponding maximum rank is ‘8’, which may be used to determine the LBRM TBS. The transport block can be scheduled by DCI format 1 or DCI format 2.

In addition, in some embodiments, the configuration may include at least a cell-specific configuration or a BWP-specific configuration. The cell-specific configuration may be used for the transmission in the serving cell regardless of the BWP. The BWP-specific configuration may be used for the transmission in the corresponding BWP in the serving cell. More specifically, the network 104 may configure a plurality of cell-specific configurations for the plurality of DCI formats, the plurality of TRP, or the plurality of panels for the user device 102. Each of the plurality of cell-specific configurations may correspond to the a DCI format, a TRP or a panel. The network 104 may configure a plurality of BWP-specific configurations for the plurality of BWPs for the user device 102. A BWP-specific configuration may include one or more configurations with each one corresponding to a DCI format, a TRP or a panel.

If at least one of plurality of the cell-specific configurations is configured, the parameter of the plurality of cell-specific configurations (e.g., the largest one, the smallest one, the indicated one, the specified one, or the corresponding one) may be used to determine the TBS or LBRM TBS in accordance with the embodiments. Else if at least one of the plurality of BWP-specific configurations is configured, the parameter of the plurality of BWP-specific configurations (e.g., the largest one, the smallest one, the indicated one, the specified one, or the corresponding one) may be used to determine the TBS or LBRM TBS in accordance with the embodiments. In other words, if the cell-specific configuration is not configured at all and at least one of the plurality of BWP-specific configurations is configured, the parameter of the plurality of BWP-specific configurations (e.g., the largest one, the smallest one, the indicated one, the specified one, or the corresponding one) may be used to determine the TBS or LBRM TBS in accordance with the embodiments.

Suppose for example, that the maximum number of MIMO layers is used to determine the TBS or the LBRM TBS for the transport block. Further, suppose that the network 104 configures two BWPs (denoted by BWP 1 and BWP 2, respectively) for a user device 102 for a serving cell. If the network 104 configures the at least one maximum number of MIMO layers for any of DCI format 1 and DCI format 2 for the serving cell (which is a cell-specific configuration used for the transmission in the serving cell), then the greatest one of the maximum number of MIMO layers for DCI format 1 and DCI format 2 may be used to determine the TBS or LBRM TBS for the transport block. If the network 104 does not configure the maximum number of MIMO layers for any of DCI format 1 and DCI format 2 for the serving cell but configures at least one of the maximum number of MIMO layers for any of DCI format 1 and DCI format 2 for any of BWP 1 and BWP 2, then the greatest one of the maximum number of MIMO layers for DCI format 1 and DCI format 2 across the two BWPs may be used to determine the TBS or LBRM TBS for the transport block.

In accordance with these embodiments, the network 104 and user device 102 may determine the TBS or LBRM TBS correctly. In this case, the receiving device may be enabled to decode the TB correctly due to the two communication nodes having the same understanding of the TBS or LBRM TBS. Otherwise, without performance of these actions, the receiving device may not receive the data channel correctly.

Additionally, in some embodiments, the network 104 may configure a time domain resource allocation (TDRA) table for indicating a time domain resource for a data channel for a user device 102. The TDRA table may include one or more entries (e.g., rows). For a given configuration, each entry (e.g., row) may include at least one of a time domain resource in a slot, a mapping type, an offset between the data channel and the control information, a number of slots (or sub-slots) for transport block over multiple slots (TBoMS) transmission and a number of repetitions. The time domain resource in the slot may include at least one of the number of orthogonal frequency-division multiplexing (OFDM) symbols and a starting OFDM symbol.

Also, different numbers of repetitions or different number of slots for TBoMS transmission may be configured for at least two of the plurality of entries (e.g., rows).

Also, in some embodiments, for a hybrid automatic repeat request (HARQ)-acknowledgment (ACK) codebook to be transmitted on a slot or a sub-slot, the HARQ-ACK codebook may be constructed according to the following.

In one action, a plurality of candidate slots and a corresponding start and length indicator value (SLIV) group may be determined for the slot or sub-slot. Also, one or more slot intervals or sub-slot intervals may be used to determine the candidate slot.

Additionally or alternatively, the network 104 may configure a first time interval configuration for the user device 102. The first time interval configuration may include one or more slot (or sub-slot) intervals that may be used to indicate the slot offset between the slot (or sub-slot) of the PUCCH resource and the slot (or sub-slot) of the data channel for multicast transmission scheduled by a first DCI format. For example, the first DCI format may be DCI format 4_2, such as for implementations where the wireless communication system 100 is configured according to NR (otherwise called an NR system). A slot interval may include one or more slots. The network 104 may configure a second time interval configuration for the user device 102. The second time interval configuration may include one or more slot (or sub-slot) intervals that may be used to indicate the slot (or sub-slot) offset between the slot (or sub-slot) of the PUCCH resource and the slot (or sub-slot) of the data channel for multicast scheduled by a second DCI format. For example, the second DCI format may be DCI format 41, such as in an NR system. The network 104 may configure a third time interval configuration for the user device 102. The third time interval configuration may include one or more slot (or sub-slot) intervals that may be used to indicate the slot (or sub-slot) offset between the slot (or sub-slot) of the PUCCH resource and the slot (or sub-slot) of the data channel for unicast transmission. The PUCCH resource may be used to carry the HARQ-ACK for the corresponding data channel.

From the user device 102 perspective, when the user device 102 is configured with the first time interval configurations, a slot offset set may be the combination (or union) of the first time interval configurations and the second time interval configurations. When the user device 102 is not configured with the first time interval configuration, the slot offset may be the combination (or union) of the third time interval configuration and the second time interval configuration. When the user device 102 is not configured with the second time interval configuration, the second time interval configuration may include some default slot (or sub-slot) offset values, e.g., {1, 2, 3, 4, 5, 6, 7, 8} in the NR system. The slot offset may be used to determine (or construct) the HARQ-ACK codebook.

To illustrate, suppose a time interval configuration includes the slot offset values {1, 3, 4, 5, 8} and another time interval configuration includes the slot offset values {2, 3, 4, 5, 7, 8, 9}. Then the combination (or union) of the two time interval configurations may include the slot offset values {1, 2, 3, 4, 5, 7, 8, 9}.

The candidate slot may include a slot with the slot offset between the slot and the slot or sub-slot for HARQ-ACK codebook transmission equal to any one of the plurality of slot intervals or sub-slot intervals. Also, the user device 102 may determine that a slot in the plurality of slots is valid. The user device 102 may do so for each slot of the plurality of slots individually or on a one-by-one basis. In event that a slot is not valid, then the invalid slot may be excluded, or not (or no longer) considered, as a candidate slot. Also, for a candidate slot, if the available resource can be used for transmitting the data channel, then the candidate slot may be considered as valid, and in turn, may be kept as a candidate slot. If the available resource cannot be used for transmitting any data channel, then the candidate slot may be considered as invalid and in turn may be excluded as a candidate slot.

In addition or alternatively, the data channel repetition or TBoMS transmission may be configured. The data channel repetitions or the TBoMS transmission may be transmitted on a plurality of slots (or consecutive slots). For a candidate slot, if any one of the plurality of consecutive slots ending with the candidate slot (e.g., the candidate slot is the last slot of the plurality of consecutive slots) is available for transmitting the data channel, the candidate slot may be considered as valid and may be kept. If none of the plurality of consecutive slots ending with the candidate slot (e.g., the candidate slot is the last slot of the plurality of consecutive slots) is available for transmitting the data channel, then the candidate slot may be considered as invalid and may be excluded. In at least some embodiments, for a valid candidate slot, the SLIV groups are determined according the time domain resource configuration of the data channel.

For example, where the wireless communication system 100 is configured according to NR, in order to determine whether a candidate slot is valid, the valid TDRA configuration for the candidate slot may be determined first. A first set may include a plurality (e.g., all) of the time domain resource allocation configurations for the data channel that can be used for the user device 102, e.g., the plurality of TDRA configurations in a TDRA table and/or a default TDRA configuration defined by the protocol. In some embodiments, these TDRA configurations in the first set may be determined for a candidate slot one by one. For a TDRA configuration for a candidate slot, if there is at least one symbol in the TDRA configuration that cannot be used for data channel transmission, then the TDRA configuration may be considered as an invalid configuration. For downlink transmission, if at least one symbol in the TDRA configuration is an uplink symbol, the TDRA configuration may be considered as an invalid configuration. Then, this TDRA configuration may be excluded from the first set. Otherwise, this TDRA configuration may be kept in the set. Assuming the number of repetitions is Y or the number of slots for TBoMS transmission is Y, for a candidate slot n, if there is at least one symbol in the TDRA configuration in each of the slots from slot n-Y+1 to slot n that cannot be used for data channel transmission, then this TDRA configuration may be considered as an invalid configuration. In turn, this TDRA configuration may be excluded from the set. Otherwise, this TDRA configuration may be kept in the set. After or at the end of finishing the determination whether each TDRA configuration in the first set is to be kept or excluded, if the first set is then not empty set (e.g., there is at least one valid TDRA configuration left in the first set), then the corresponding candidate slot is valid. However, if the set is empty (e.g., there is no valid TDRA configuration left in the first set), then the corresponding candidate slot is not valid. In case that the network 104 configures more than one TDRA table for the user device 102, the first set may include all of the time domain resource allocation configurations in the combination of the more than one TDRA table.

In addition or alternatively, in one implementation, a maximum (largest) or smallest number of repetitions (or slots for TBoMS transmission) across the plurality entries (e.g., rows) may be used to determine, construct (or generate) a HARQ-ACK codebook. In particular of these implementations, the maximum number of the repetitions (or slots for TBoMS transmission) across the plurality of entries (e.g., rows) may be used to determine whether a TDRA configuration is valid. For example, the network 104 may configure that a TDRA table includes three TDRA configurations and the number of repetitions (or slots for TBoMS transmission) are 2, 3, and 4 for the first, second, and third TDRA configurations, respectively. In turn, the largest number of repetitions (or slots for TBoMS transmission)—i.e., 4 in this example, may be used to determine any of the TDRA configurations (e.g., any of the first, second and/or third TDRA configurations) in the set. In case that the network 104 configures more than one TDRA table for the user device 102, a maximum (largest) or smallest number of repetitions (or slots for TBoMS transmission) across the plurality entries (e.g., rows) across the more than one TDRA table may be used to construct (or generate) a HARQ-ACK codebook. The network 104 may configure more than one TDRA tables for a plurality of DCI formats, or a plurality of panels or TRPs, or DL BWP and DL sub-band, or UL BWP and UL sub-band respectively.

In another implementation, the number of repetitions (or slots for TBoMS transmission) for each entry (e.g., row) may be used to construct (or generate) the HARQ-ACK codebook. In particular of these implementations, the number of the repetitions (or slots for TBoMS transmission) of a TDRA configuration may be used to determine whether this TDRA configuration is valid. To illustrate using the above example, the number of repetitions (or slots for TBoMS transmission) ‘2’ may be used to determine whether the corresponding first TDRA configuration is valid; the number of repetitions ‘3’ may be used to determine whether the corresponding second TDRA configuration is valid; and the number of repetitions ‘4’ may be used to determine whether the corresponding third TDRA configuration is valid.

In another implementation, more than one entry (e.g., row) may have the same time domain resource (e.g., the same starting OFDM symbol and the same number of OFDM symbols) for the TDRA configuration. The more than one entry (e.g., row) may have the same or different number of repetitions (or slots for TBoMS transmission). The maximum (largest) or smallest number of repetitions (or slots for TBoMS transmission) across the more than one entry (e.g., row) may be used to determine, construct (or generate) a HARQ-ACK codebook. In particular of these implementations, the maximum (largest) or smallest number of the repetitions (or slots for TBoMS transmission) across the more than one entry (e.g., row) may be used to determine whether the TDRA configuration of one of the more than one entry (e.g., row) is valid.

After determining (or constructing, or generating) the HARQ-ACK codebook, the user device 102 may transmit the HARQ-ACK codebook to the network 104.

In addition, in some embodiments, a maximum (largest) or smallest number of slots for TBoMS transmission across the plurality entries (e.g., rows) may be used to determine the TBS or the LBRM TBS for the transport block. More specifically, the maximum (largest) or smallest number of slots for TBoMS transmission across the plurality entries (e.g., rows) may be used to determine the resource size. To illustrate using the above example, the largest number of slots for TBoMS transmission—e.g., 4 may be used to determine the resource size for TBS or LBRM TBS determination. The resource size may be 4*Sₛₗₒₜ, where Sₛₗₒₜ is the resource size in a slot, e.g., the first slot of the TBoMS transmission. In case that the network 104 configures more than one TDRA table for the user device 102, a maximum (largest) or smallest number of slots for TBoMS transmission across the plurality entries (e.g., rows) across the more than one TDRA table may be used to determine the TBS or the LBRM TBS for the transport block. The network 104 may configure more than one TDRA table for a plurality of DCI formats, TRPs, or panels respectively. Additionally or alternatively, the network 104 may configure more than one TDRA table for a plurality of BWPs or a plurality of combinations of DCI format (or TRP, or panels) and BWP (or DL sub-band, or UL sub-band), respectively.

In another implementation, the number of repetitions slots for TBoMS transmission for an entry (e.g., row) may be used to determine the TBS or the LBRM TBS for the transport block with the TDRA resource indicated by the entry (e.g., row). More specifically, the number of repetitions slots for TBoMS transmission for an entry (e.g., row) may be used to determine the resource size for TBS or the LBRM TBS calculation for the transport block with the TDRA resource indicated by the entry (e.g., row). To illustrate using the above example, the number of slots for TBoMS transmission ‘2’ may be used to determine the resource size for the TBS or the LBRM TBS calculation for the transport block if the first TDRA configuration is indicated for the transport block; the number of repetitions ‘3’ may be used to determine the resource size for the TBS or the LBRM TBS calculation for the transport block if the second TDRA configuration is indicated for the transport block; and the number of repetitions ‘4’ may be used to determine the resource size for TBS or the LBRM TBS calculation for the transport block if the third TDRA configuration is indicated for the transport block.

With these embodiments, the network 104 and the user device 102 may determine the TBS, the LBRM TBS and/or HARQ-ACK codebook size correctly. The network 104 and the user device 102 may have the same understanding of the TBS, the LBRM TBS and/or the HARQ-ACK codebook size. In this case, the receiving device may be enabled to decode the TB or HARQ-ACK codebook correctly. Otherwise, without performance of these actions, the receiving device may not receive the data channel or the HARQ-ACK codebook correctly.

In addition or alternatively, the network 104 may configure at least a cell-specific TDRA table or a UE-specific TDRA table for the user device 102. For example, in a NR system, the cell-specific TDRA table may be provided by higher layer parameter PUSCH-ConfigCommon and the UE-specific TDRA table may be provided by higher layer parameter PUSCH-Config. A default TDRA table may be defined for the user device 102. A DCI may be scrambled by temporary cell radio network temporary identifier (TC-RNTI). The DCI may schedule at least one data channel. The data channel may be a PUSCH or a PDSCH. The data channel may be used for the third message transmission during random access procedure. The user device 102 may receive or transmit the data channel from or to the network 104.

In one implementation, when the user device 102 is not configured with a cell-specific TDRA table, the default TDRA table may be used for time domain resource allocation for the data channel. More specifically, in this case, the default TDRA table may be used for time domain resource allocation for the data channel regardless of whether the UE-specific TDRA table is configured. When the user device 102 is configured with a cell-specific TDRA table, the cell-specific TDRA table may be used for time domain resource allocation for the data channel. More specifically, in this case, the cell-specific TDRA table may be used for time domain resource allocation for the data channel regardless of whether the UE-specific TDRA table is configured.

In one implementation, a first user device 102 may perform contention-based random access to the network 104. When performing contention-based random access to the network 104, the first user device 102 may select a PRACH resource (e.g., preamble resource) for random access. More than one user device 102 may select the same PRACH resource (e.g., preamble resource) and a collision may happen. When the first user device 102 is not configured with cell-specific TDRA table, the default TDRA table may be used for time domain resource allocation for the data channel. When the first user device is configured with cell-specific TDRA table, the cell-specific TDRA table may be used for time domain resource allocation for the data channel. A second user device 102 may perform contention-free random access to the network 104, in which the network 104 indicates the PRACH resource (e.g., preamble resource) for the second user device 102 for random access. There may be no PRACH resource collision. When the second user device 102 is not configured with a cell-specific TDRA table or a UE-specific TDRA table, the default TDRA table may be used for time domain resource allocation for the data channel. When the second user device 102 is configured with a cell-specific TDRA table but is not configured with a UE-specific TDRA table, the cell-specific TDRA table may be used for time domain resource allocation for the data channel. When the second user device 102 is configured with a UE-specific TDRA table, the UE-specific TDRA table may be used for time domain resource allocation for the data channel. More specifically, in this case, the UE-specific TDRA table may be used for time domain resource allocation for the data channel regardless of whether the cell-specific TDRA table is configured.

With these embodiments, the network 104 and the user device 102 may determine the TDRA table correctly for the data channel. The network 104 and the user device 102 may have the same understanding of the TDRA table for the data channel. In this case, the receiving device may be enabled to decode the TB correctly. Otherwise, without performance of these actions, the network 104 may not be able to receive the data channel correctly.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes.

Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: receiving, by a user device, a plurality of configurations, wherein each configuration includes at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions; determining, by the user device, a transport block size (TBS) based on at least one of the plurality of configurations; and communicating, by the user device, a transport block with the TBS.

A second aspect includes a method for wireless communication that includes: transmitting, by a network device, a plurality of configurations, wherein each configuration includes at least one of: a maximum number of layers, a maximum rank, a modulation and coding scheme (MCS) table configuration, a frequency resource size, a maximum modulation order, a maximum code rate, a number of slots for transport block over multiple slots (TBoMS) transmission, or a number of repetitions; and communicating, by the network device, a transport block with a transport block size (TBS) determined based on at least one of the plurality of configurations.

A third aspect includes any of the first or second aspects, and further includes wherein each of the plurality of configurations corresponds to at least one of or a respective combination of: a respective downlink control information (DCI) format, a respective transmission reception point (TRP), a respective panel, a respective bandwidth part (BWP), or a respective sub-band.

A fourth aspect includes any of the first through third aspects, and further includes wherein the TBS includes a limited buffer rate matching (LBRM) TBS, and wherein for a data channel, a largest value or a smallest value of the plurality of configurations is used to determine the LBRM TBS.

A fifth aspect includes any of the first or second aspects, and further includes wherein the TBS includes a limited buffer rate matching (LBRM) TBS, and wherein a value for a downlink control information (DCI) format in one of the plurality of configurations is used to determine the LBRM TBS.

A sixth aspect includes the fifth aspect, and further includes wherein the value for the DCI format includes a largest value or a smallest value for a plurality of DCI formats in the plurality of configurations.

A seventh aspect includes the fifth aspect, and further includes wherein the value for the DCI format includes a largest value or a smallest value for the DCI format in the plurality of configurations.

An eighth aspect includes the seventh aspect, and further includes wherein the plurality of configurations includes a subset of configurations, wherein each configuration in the subset includes a respective value for the DCI format and for a respective one of one or more bandwidth parts (BWPs).

A ninth aspect includes any of the first through eighth aspects, and further includes wherein the TBS includes a limited buffer rate matching (LBRM) TBS, and wherein a value for a transmission reception point (TRP) or a panel in one of the plurality of configurations is used to determine the LBRM TBS.

A tenth aspect includes the ninth aspect, and further includes wherein the value for the TRP or the panel includes a largest value or a smallest value for a plurality of TRPs or for a plurality of panels in the plurality of configurations.

An eleventh aspect includes the ninth aspect, and further includes wherein the value for the TRP or the panel includes a largest value or a smallest value for the TRP or the panel in the plurality of configurations. A twelfth aspect includes any of the first through eleventh aspects, and further includes wherein the TBS includes a limited buffer rate matching (LBRM) TBS, and wherein a value for a bandwidth part (BWP) or a sub-band in one of the plurality of configurations is used to determine the LBRM TBS.

A thirteenth aspect includes the twelfth aspect, and further includes wherein the value for the BWP or the sub-band comprises a largest value or a smallest value for aplurality of BWPs or a plurality of sub-bands in the plurality of configurations.

A fourteenth aspect includes the twelfth aspect, and further includes wherein the value for the BWP or the sub-band includes a largest value or a smallest value for the BWP or the sub-band in the plurality of configurations.

A fifteenth aspect includes any of the first through fourteenth aspects, and further includes wherein each of the plurality of configurations corresponds to respective one of a plurality of time domain resource allocation (TDRA) configurations.

A sixteenth aspect includes the fifteenth aspect, and further includes wherein the TBS includes a limited buffer rate matching (LBRM) TBS, and wherein for a data channel allocated with one of the plurality of time domain resource allocation (TDRA) configurations, a value for the one of the plurality of time domain resource allocation (TDRA) configurations is used to determine the LBRM TBS.

A seventeenth aspect includes the sixteenth aspect, and further includes wherein the value for the one of the plurality of time domain resource allocation (TDRA) configurations includes a largest value or a smallest value for the plurality of time domain resource allocation (TDRA) configurations.

An eighteenth aspect includes the sixteenth aspect, and further includes wherein a number of repetitions associated with a TDRA configuration is used to determine whether the TDRA configuration is valid.

A nineteenth aspect includes the sixteenth aspect, and further includes wherein a largest number of repetitions among the plurality of TDRA configurations is used to determine whether one of the plurality of TDRA configurations is valid.

A twentieth aspect includes a wireless communications apparatus including a processor and a memory, wherein the processor is configured to read code from the memory to implement any of the first through nineteenth aspects.

A twenty-first aspect includes a computer program product including a computer-readable program medium comprising code stored thereupon, the code, when executed by a processor, causing the processor to implement any of the first through nineteenth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, by a user device, a plurality of configurations, wherein each configuration comprises at least one of: a maximum number of layers or a maximum rank;
determining, by the user device, a transport block size (TBS) based on at least one of the plurality of configurations; and
communicating, by the user device, a transport block with the TBS.

2. The method of claim 1, wherein each of the plurality of configurations corresponds to at least one of: a respective panel or a respective bandwidth part (BWP).

3. The method of claim 1, wherein the TBS comprises a limited buffer rate matching (LBRM) TBS, and wherein for a data channel, a largest value of the plurality of configurations is used to determine the LBRM TBS.

4. The method of claim 1, wherein the TBS comprises a limited buffer rate matching (LBRM) TBS, wherein the plurality of configurations is for a panel across one or more bandwidth parts (BWPs), and wherein a largest maximum rank in the plurality of configurations for the panel across the one or more BWPs is used to determine the LBRM TBS.

5. A non-transitory computer-readable storage medium comprising a plurality of instructions stored thereupon, the plurality of instructions, when executed by at least one processor, causing the at least one processor to implement the method of claim 1.

6. A method for wireless communication, the method comprising:
transmitting, by a network device, a plurality of configurations, wherein each configuration comprises at least one of: a maximum number of layers or a maximum rank; and
communicating, by the network device, a transport block with a transport block size (TBS) determined based on at least one of the plurality of configurations.

7. The method of claim 6, wherein each of the plurality of configurations corresponds to at least one of: a respective panel or a respective bandwidth part (BWP).

8. The method of claim 6, wherein the TBS comprises a limited buffer rate matching (LBRM) TBS, and wherein for a data channel, a largest value of the plurality of configurations is used to determine the LBRM TBS.

9. The method of claim 6, wherein the TBS comprises a limited buffer rate matching (LBRM) TBS, wherein the plurality of configurations is for a panel across one or more bandwidth parts (BWPs), and wherein a largest maximum rank in the plurality of configurations for the panel across the one or more BWPs is used to determine the LBRM TBS.

10. A wireless communications apparatus comprising at least one processor and a memory storing a plurality of instructions, wherein the at least one processor is configured to execute the plurality of instructions, and upon execution of the plurality of instructions, configured to implement the method of claim 6.

11. A non-transitory computer-readable storage medium comprising a plurality of instructions stored thereupon, the plurality of instructions, when executed by at least one processor, causing the at least one processor to implement the method of claim 6.

12. A wireless communications apparatus comprising:
a memory storing a plurality of instructions; and
at least one processor configured to execute the plurality of instructions, wherein upon execution of the plurality of instructions, the at least one processor is configured to cause the wireless communications apparatus to:
receive a plurality of configurations, wherein each configuration comprises at least one of: a maximum number of layers or a maximum rank;
determine a transport block size (TBS) based on at least one of the plurality of configurations; and
communicate a transport block with the TBS.

13. The wireless communications apparatus of claim 12, wherein each of the plurality of configurations corresponds to at least one of: a respective panel or a respective bandwidth part (BWP).

14. The wireless communications apparatus of claim 12, wherein the TBS comprises a limited buffer rate matching (LBRM) TBS, and wherein for a data channel, a largest value of the plurality of configurations is used to determine the LBRM TBS.

15. The wireless communications apparatus of claim 12, wherein the TBS comprises a limited buffer rate matching (LBRM) TBS, wherein the plurality of configurations is for a panel across one or more bandwidth parts (BWPs), and wherein a largest maximum rank in the plurality of configurations for the panel across the one or more BWPs is used to determine the LBRM TBS.
